(19) United States
(12) Patent Application Publication
(10) Pub. No.: US 2008/0184606 A1
(43) Pub. Date: Aug. 7, 2008

(54) Alternate appearance cover for electrophotographic machines

(75) Inventors: Randall E. Kaufman, Rochester, NY (US); Chad E. Labarge, Fairport, NY (US); Karen D. Reid, Walworth, NY (US)

Correspondence Address: JAMES J. RALABATE, 5792 MAIN ST., WILLIAMSVILLE, NY, 14221, US

(73) Assignee: Xerox Corporation

(21) Appl. No.: 11/702,765

(22) Filed: Feb. 6, 2007

(51) Int. Cl. G09F 7/12; G09F 23/00

(52) U.S. Cl. 40/594; 40/606.03

(57) ABSTRACT

This is a xerographic or electrophotographic marking machine having a plurality of doors or panels that open into the interior of the machine. The present embodiments provide a covering or skin that can be attached to the exterior of these doors or panels to change their appearance or to have a logo on the skin, or to have the color of the skin provide information. The thickness of the skin should not exceed the space between adjacent doors or panels when they are closed. A thickness of from 1-3 mm in our tests accommodated this space limitation.

This invention relates generally to electrophotographic marking machines and more specifically to thin skinned removable covers for exterior machine parts.

### BACKGROUND

In Xerography or an electrostatographic marking machine and process, a uniform electrostatic charge is placed upon a photoreceptor surface. The charged surface is then exposed to a light image of an original to selectively dissipate the charge to form a latent electrostatic image of the original. The latent image is developed by depositing finely divided and charged particles of toner upon the photoreceptor surface. The charged toner being electrostatically attached to the latent electrostatic image areas to create a visible replica of the original. The developed image is then usually transferred from the photoreceptor surface to a final support material, such as paper, and the tone image is fixed thereto to form a permanent record corresponding to the original.

In most Xerographic copiers or printers, a photoreceptor surface is generally arranged to move in an endless path through the various processing stations of the xerographic process. Since the photoreceptor surface is reusable, the toner image is then transferred to a final support material, such as paper, and the surface of the photoreceptor is prepared to be used once again for the reproduction of a copy of an original. In this endless path, several conventional Xerographic related stations are traversed by the photoconductive belt. These “conventional” stations include charge stations, exposure stations, development stations, transfer stations, detach stations, fusing stations and cleaning stations.

When a problem develops in any of these conventional stations, access to the stations is usually preceded by opening separate outside doors or covers that are adjacent each station. These doors or covers are generally located on the front or sides of the copier machine and constitute the exterior appearance of the machine.

In some instances customers request customization of their machines to include their company logo or to make them more attractive by, in some cases, fitting into the decor of their room or office, i.e. same color or with paneling, etc. Also, as noted above, access to the various stations can be simplified by color coding each door, for example, access door to development station could be blue, to the fuser station red, etc. To change the exterior design or color or appearance by replacing each door or panel would be an expensive proposition. Also, for resale or renting of copier machines, it doesn't make economic sense to expend substantial costs in accommodating these above objectives. In addition, tooling costs for new doors or to change door designs would involve expenditures of at least 100 thousand dollars.

### SUMMARY

This invention provides use of inexpensive removable covers attachable to the outside doors or other exterior parts of Xerographic products in order to change their appearance or to convey information. The intent is to provide flexibility in accommodating cover design changes without the expense of making new tooling. The invention and its embodiments provide the use of thin (1-3 mm) vacuum formed “skins” or covers. These “skins” would attach to the existing covers with an adhesive or other suitable attachment means and provide for options such as customer logos, color matching, color-coded access door to stations or other corporate identity changes. These thin “skins” do not impair structural integrity because the original covers are still there together with this skin new surface. Also, by capturing all four edges of a door or panel, this skin permits lesser strength adhesives to be used.

These doors or covers are easily removable if the customer desires a different design or color, or if the machine is to be resold. Also, when machines are rented, the machine supplier such as Xerox Corp. can easily remove the plastic skin or cover for a new rental customer's desired design. This thin-skinned, vacuum-formed plastic cover, therefore, could be used at a low cost and easily fastened to the outside of a door (or panel) for a new look. There are different ways to fasten the outer skin or cover to the door or panel; one way is to use double back adhesive on the inside of the skin or cover and press it and adhere it over the door or panel. Structurally, the door or panel is still as strong as originally designed but with the desired unique look.

The thickness of the removable skin or cover of this invention is generally governed by the tolerances or space between the adjacent doors or panels to be covered. In one embodiment the use o 1-3 mm thick skins gave exceptional results of wear, cost and fit. Obviously, any suitable thickness could be used provided it does not interfere with the tolerances between doors such as preventing opening and closing of doors.

Vacuum forming is an ideal and preferred method for forming the skin or cover of this invention. This method, for example, involves costs of about 10% the cost of injection molding and therefore is the method of choice. Since the skins or covers are disposable and removable, costs become an important consideration. A typical vacuum forming process is illustrated in FIG. 4. Typical materials suitable for the skin are ABS, polycarbonate, polypropylene, Acrylic PVC and HDPE. Obviously, any design, logo or color may be used on the skin and as noted the skin is easily attached and removed from the original doors or panels. Items can be put in or on these skins such as information, pockets, maintenance and repair instructions, if desired. Thickness as noted earlier will be determined by factors such as wearability, spaces or tolerances between doors, and other structural considerations.

### BRIEF DESCRIPTION OF THE DRAWINGS

FIG. 1 illustrates an embodiment of the exterior of a skin shown with the exterior door of the door or panel it will coat or cover.

FIG. 2 illustrates an embodiment of the interior surface of a skin with an adhesive on the inside for attachment to a door or panel.

FIG. 3 is a general illustration of a typical Xerographic system or apparatus.

FIG. 4 illustrates a typical vacuum forming process.

FIG. 5 illustrates a typical xerographic machine frame work showing doors or panels to be covered by skins.

### DETAILED DESCRIPTION OF DRAWINGS AND PREFERRED EMBODIMENTS

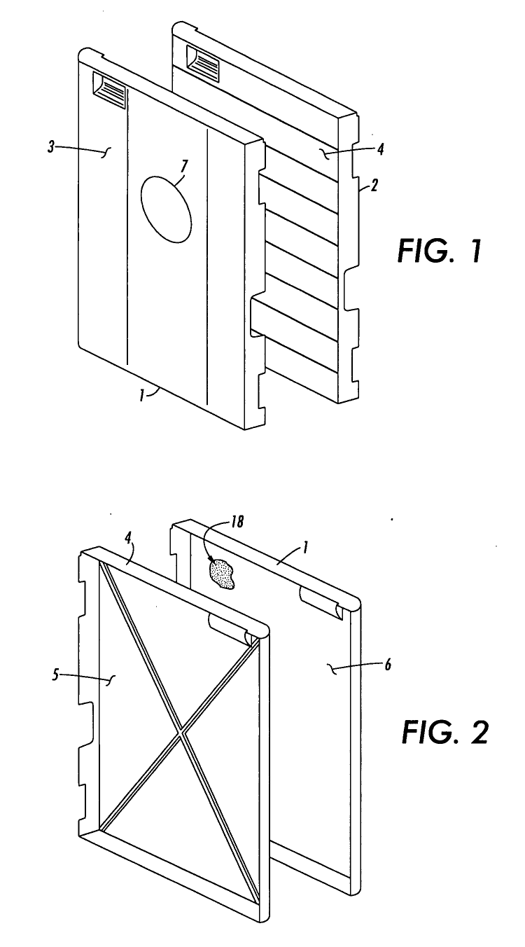

In FIGS. 1 and 2, an embodiment of the skin 1 of this invention is illustrated. In FIG. 1, the exterior surface 3 of new designed or color skin 1 is shown as compared to the exterior design 4 of old door or panel 2. With the new skin 1 with a logo 7, a new color or design, a new look is conveyed to exterior surface 4 door or panel 2. In FIG. 2, the inner surface 5 of door 2 is shown adjacent the inner surface 6 of skin 1. Any suitable adhesive or connector 18 can be used to attach the inner surface of skin 6 to the outer surface 4 of door or panel 2. Note in FIG. 1 the design change in the outer surface 4 of door 2, for example, from horizontal stripes to skin design vertical stripes with a logo 7. Note the conformity of the shape of the skins 1 with the shape of doors or panels 2.

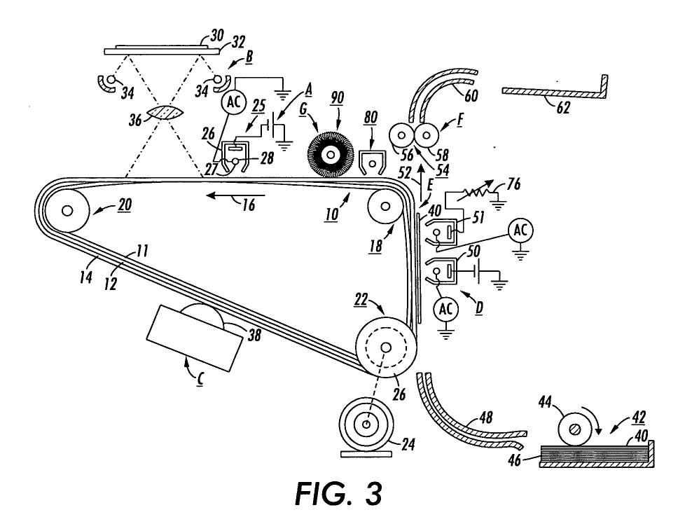

In FIG. 3, a typical electrophotographic system or machine is illustrated. Since this structure is well known, it is not necessary to give a detailed description of this type machine. The following numbered elements define each machine component: photoconductive belt (10), electrically conductive substrate (11), charge generator layer (12), photoconductive particles dispersed in electrically insulating organic resin (13), charge transport layer (14), directional arrow (16), stripping roller (18), tension roller (20), drive roller (22), motor (24), corona device (25) conductive shield (26), dicorotron electrode comprised of elongated bar wire (27), electrically insulating layer (28), original document (30), transparent platen (32), lamps (34), lens (36), magnetic brush developer roller (38), sheet of support material (40), sheet-feeding apparatus (42), feed roll (44), stack (46), chute (48), corona-generating device (50), directional arrow (52), fuser assembly (54), heated fuser roller (56), backup roller (58), fusing sheet (60), catch tray (62), resistor (76), diode (78), shield circuit of a preclean dicorotron (80) and conventional cleaning station (90). The following letter designations indicate the “convention” processing stations mentioned throughout this disclosure: charging station (A), exposure station (B), development station (C), transfer station (D), detack station (E), fusing station (F) and cleaning station (G).

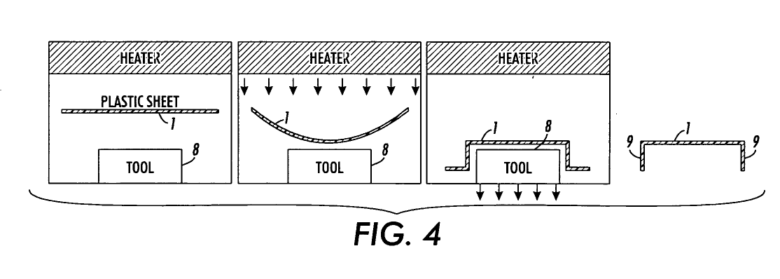

In FIG. 4, a typical vacuum-forming process is illustrated wherein the plastic sheet of the skin 1 is placed over tool 8. The sheet 1 is then heated until soft and draped over tool 8. Vacuum pressure is applied to draw the sheet 1 over tool 8 to form the skin structure. The sides 9, if necessary, are trimmed and part 1 is finished. Description of a vacuum forming process usable in the present invention: A low cost alternative for fabricating plastic “shell” or skin type parts such as enclosures, trays, etc. A soft type tool is machined (soft steel, aluminum, wood, etc.) to serve as the internal volume of the part. A plastic sheet is heated and drawn over the tool via vacuum pressure to form the skin. Costs of the tool are typically 10-20% the cost of an injection mold. An injection mold consists of two halves and requires air venting, flow ports and other precise features. A vacuum-forming tool is a single piece. Component parts can be selected from ABS, polycarbonate, polypropylene, acrylic PVC and HDPE depending on the requirements for formability, chemical resistance, flammability, etc.

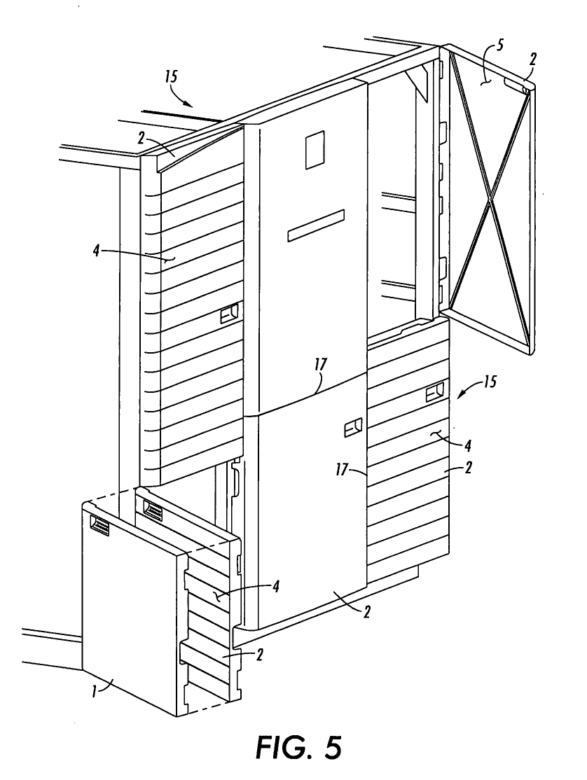

In FIG. 5, a xerographic machine frame 15 into which the stations and the components of FIG. 3 are ultimately housed is shown. The doors or panels 2 to be covered are shown in both an open and closed position. These doors or panels 2 permit easy access to the interior of the Xerographic machine as illustrated in FIG. 3. The doors 2 have an interior surface 5 and an exterior surface 4. The exterior surface 4 is the door portion that will be covered by the skin 1 of this invention. An embodiment of skin 1 is shown in the bottom-left hand section of the xerographic machine prior to attachment to door 2. In the drawing of FIG. 5, a door design is shown made up of horizontal lines or a solid light color in the central door. The skin 1 to be attached to the door 2 is a dark black in FIG. 5, but can be any color or just a different design. The thickness of the skin 1 should not exceed the space 17 between doors or panels.

In summary, embodiments of this invention provide an electrophotographic marking machine comprising in an operative arrangement, an outside structure or housing, conventional processing stations located sequentially within the housing and doors or access panels to the machine interior located in the housing. At least one of the doors or panels has removably coated thereon by a connector, a plastic skin or cover which conforms substantially to the exterior structure of the doors or panels. These doors or panels are adjacent each other with a space or gap therebetween. The skin has a thickness not exceeding the space or gap. This plastic skin has a color or design different from the original color or design on the doors or panels. In one embodiment, the skin or cover is made by a vacuum-forming process. The skin is constructed of a member selected from the group consisting of ABS, polycarbonate, polypropylene, acrylic PVC, HDPE and mixtures thereof. The skin has a double-backed adhesive or connector for attachment of the skin to the doors or panels. The removal of the skin from the door or panels is accomplished by removal of the skin-door connector. The skin in one embodiment has a thickness of from about 1-3 mm. These access panel(s) or doors permit entrance to an interior of the housing and each of the doors or panels is color coded using the skins to designate the station or stations accessible from the access panel(s) or doors.

In a preferred embodiment, this marking machine comprises in an operative arrangement, an outside housing, conventional processing stations located sequentially within the interior of the housing and exterior movable doors or panels that permit access to the interior of the machine and permit access to all of the processing stations. The doors or panels are positioned adjacent at least one processing station and the doors or panels are located adjacent each other on the interior and exterior of the housing. A space or gap or separation is located between each door or panel to permit easy opening and closing of the door or panel. Each door or panel has a predetermined size, configuration, color or design. The plastic cover or skin is enabled to cover substantially all of an exterior portion of the door or panel The skin has substantially the same size and configuration of the doors or panels except for a skin portion that fits beyond the door or panel into the space or separation between each door or panel.

In one embodiment, the marking machine comprises a skin that has a connection or adhesive for attachment to the doors or panels. The marking machine has a skin that attaches to all four edges of a door or panel and thereby provides a stronger adhesion to the door or panel outer surface.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An electrophotographic marking machine comprising in an operative arrangement, an outside structure or housing, conventional processing stations located sequentially within said housing, and doors or access panels to the machine interior located in said housing, at least one of said doors or panels having removably coated thereon by a connector, a plastic skin or cover which conforms substantially to the exterior structure of said doors or panels, said doors or panels adjacent each other with a space or gap there between, said skin having a thickness not exceeding said space or gap, said plastic skin having a color or design different from an original on said doors or panels.

2. The marking machine of claim 1 wherein said skin or cover is made by a vacuum forming process.

3. The marking machine of claim 1 wherein said skin is constructed of a member selected from the group consisting of ABS, polycarbonate, polypropylene, Acrylic PVC, HDPE and mixtures thereof.

4. The marking machine of claim 1 wherein said skin has a double-backed connector for attachment to said doors or panels.

5. The marking machine of claim 1 wherein removal of said skin from said door or panels is accomplished by removal of said skin-door connector.

6. The skin of claim 1 having a thickness of from about 1-3 mm.

7. The marking system of claim 1 wherein said access panel(s) permit entrance to an interior of said housing and wherein each of said panels is color coded using said skins to designate the said station or stations accessible from said access panel(s).

8. An electrophotographic marking machine comprising in an operative arrangement, an outside housing, conventional processing stations located sequentially within the interior of said housing, and exterior movable doors or panels that permit access to the interior of said machine and permit access to all of said processing stations, said doors or panels positioned adjacent at least one processing stations, said doors or panels located adjacent each other on the exterior of said housing, a space or gap between each door or panel to permit easy opening and closing of said door or panel, each door or panel having a predetermined size, configuration, color, or design, a plastic cover or skin enabled to cover substantially all of an exterior portion of said door or panel, said skin having substantially the same size and configuration of said doors or panels except for a skin portion that fits beyond said door or panel into said space between each door or panel.

9. The marking machine of claim 8 wherein said skin or cover is made by a vacuum forming process.

10. The marking machine of claim 8 wherein said skin is constructed by a member selected from the group consisting of AB's, polycarbonate, polypropylene, Acrylic, PVC, HDPE and mixtures thereof.

11. The marking machine of claim 8 wherein said skin has a connection for attachment to said doors or panels.

12. The marking machine of claim 8 wherein removal of said skin from said door or panels is accomplished by removal of a skin-door connection.

13. The skin of claim 8 having a thickness of from about 1-3 mm.

14. The marking machine of claim 8 wherein said skin attaches to all four edges of a door or panel and thereby provides a stronger adhesion to said door or panel outer surface.
